(19) United States
(12) Patent Application Publication
(10) Pub. No.: US 2024/0333862 A1
(43) Pub. Date: Oct. 3, 2024

(54) IMAGE PROCESSING DEVICE, READING DEVICE, IMAGE FORMING APPARATUS, DATA MANAGEMENT SYSTEM, BIOLOGICAL IMAGING APPARATUS, AND IMAGE PROCESSING METHOD

(71) Applicant: Ayumu HASHIMOTO, Kanagawa (JP)

(72) Inventor: Ayumu HASHIMOTO, Kanagawa (JP)

(21) Appl. No.: 18/621,172

(22) Filed: Mar. 29, 2024

(30) Foreign Application Priority Data
Mar. 31, 2023 (JP) 2023-058946
Dec. 18, 2023 (JP) 2023-213375

(51) Int. Cl. H04N 1/60; G06V 10/60; H04N 1/40

(52) U.S. Cl. CPC H04N 1/6005; G06V 10/60; H04N 1/40012

(57) ABSTRACT

An image processing device includes a first sensor having a sensitivity of a visible wavelength range, to read visible image data of an object, a second sensor having a sensitivity of an invisible wavelength range to read invisible image data of the object, and circuitry that performs a color correction to correct a color of at least one of saturation or brightness to the visible image data based on the invisible image data at a same position with a position of the visible image data to generate image data.

### CROSS-REFERENCE TO RELATED APPLICATIONS

This patent application is based on and claims priority pursuant to 35 U.S.C. § 119(a) to Japanese Patent Application No. 2023-058946, filed on Mar. 31, 2023, in the Japan Patent Office, and Japanese Patent Application No. 2023-213375, filed on Dec. 18, 2023, in the Japan Patent Office, the entire disclosure of each is hereby incorporated by reference herein.

### BACKGROUND

### Technical Field

Embodiments of the present disclosure relate to an image processing device, a reading device, an image forming apparatus, a data management system, a bioimaging apparatus, and an image processing method.

### Related Art

In the related art, an optical character recognition (OCR) technology that automatically extracts character information from a scanned image is known. For example, when a company name is imprinted on a document, there is a case where OCR processing is executed to the document after a predetermined color has been removed using a color dropout function in order to remove the imprint.

For example, in a camera, in order to correct color information in a dark region on a portion of the object, a technology that corrects the color information in the dark region using color information obtained from a region having high saturation information or a region having high brightness information in a region of a visible light image corresponding to the object region extracted from infrared light image data is known.

### SUMMARY

According to an embodiment of the present disclosure, an image processing device includes a first sensor having a sensitivity of a visible wavelength range, to read visible image data of an object, a second sensor having a sensitivity of an invisible wavelength range to read invisible image data of the object, and circuitry that performs a color correction to correct a color of at least one of saturation or brightness to the visible image data based on the invisible image data at a same position with a position of the visible image data to generate image data.

According to an embodiment of the present disclosure, a reading device includes the image processing device, a visible light source to emit light having a visible wavelength range to the object, and an invisible light source to emit light having an invisible wavelength range to the object. The first sensor receives reflection light, having visible wavelength, reflected from the object and outputs the visible image data, and the second sensor receives reflection light, having an invisible wavelength, reflected from the object; and outputs the invisible image data.

According to an embodiment of the present disclosure, an image forming apparatus includes the image processing device and an image forming unit to form an image based on the image data generated by the image processing device.

According to an embodiment of the present disclosure, a data management system includes the image processing device and an information processing device to link the visible image data sent from the image processing device and the image data generated by the circuitry, to manage the visible image data and the image data.

According to an embodiment of the present disclosure, a biological imaging apparatus includes comprising the image processing device according to claim 1.

According to an embodiment of the present disclosure, an image processing method includes causing a first sensor having a first sensitivity in a visible wavelength range to acquire visible image data of an object, causing a second sensor having a second sensitivity in an invisible wavelength range to acquire invisible image data of the object, and performing a color correction to correct a color of at least one of saturation or brightness to the visible image data based on the invisible image data at a same position with a position of the visible image data to generate image data.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating a configuration of an image processing device according to a first embodiment of the present disclosure;

FIG. 2 is a graph of a spectrum in the case where near-infrared light is used as invisible light;

FIG. 3 is a graph of light absorptance of color materials;

FIG. 4 is a diagram illustrating a configuration of a reading device according to an embodiment of the present disclosure;

FIG. 5 is a diagram illustrating a configuration of a control block of a reading device according to an embodiment of the present disclosure;

FIG. 6 is a schematic diagram illustrating a configuration that corrects a black character at a time of removing an imprint;

FIG. 7 is a flowchart of image processing according to the first embodiment of the present disclosure;

FIG. 8 is a diagram illustrating an effect of a correction level that switches low saturation or low brightness based on near-infrared density level;

FIG. 9A is a diagram illustrating a visible image to be input in a near-infrared color correction unit;

FIG. 9B is a diagram illustrating an invisible image to be input in the near-infrared color correction unit;

FIG. 9C is a diagram illustrating processed image data after color correction processing;

FIG. 9D is a diagram illustrating an image after removing an imprint;

FIG. 10A is a diagram illustrating an image after removing a predetermined color by a typical method;

FIG. 10B is a diagram illustrating an image having a scratch portion after removing a predetermined color by a typical method;

FIG. 10C is a diagram illustrating an image having a lost portion after removing a predetermined color by a typical method;

FIG. 11 is a diagram illustrating a configuration of a reading device according to a first modification of the present disclosure;

FIG. 12 is a diagram illustrating a configuration of a reading device according to a second modification of the present disclosure;

FIG. 13 is a diagram illustrating a configuration of a reading device according to a third modification of the present disclosure;

FIG. 14 is a diagram of a data management system to which the reading device in FIG. 13 is applied;

FIG. 15A is a diagram illustrating a near-infrared density level extraction unit according to a fourth modification of the present disclosure;

FIG. 15B is a diagram illustrating N-level conversion processing in an N-level conversion processing unit;

FIG. 15C is a diagram illustrating a near-infrared image in which an imprint slightly emerges;

FIG. 16A is a diagram illustrating a near-infrared color correction unit including a threshold value determination unit;

FIG. 16B is a diagram illustrating a near-infrared reading image;

FIG. 16C is a diagram illustrating a determination of a threshold value;

FIG. 17 is a diagram illustrating a configuration of a near-infrared density level extraction unit according to a sixth modification of the present disclosure;

FIG. 18 is a diagram illustrating processing in a saturation and brightness correction unit according to a seventh modification of the present disclosure;

FIG. 19 is a diagram illustrating a user interface screen that performs saturation adjustment and brightness adjustment in the saturation and brightness correction unit;

FIG. 20A is a diagram illustrating a configuration for removing a predetermined color of a ruled line;

FIG. 20B is a diagram illustrating a configuration of a user interface including a setting unit to remove a predetermined color;

FIG. 21 is a diagram illustrating a configuration of an image correction unit according to an eighth modification;

FIG. 22 is a diagram illustrating a configuration of an image correction unit according to a ninth modification;

FIG. 23 is a diagram illustrating a configuration of an image correction unit according to a tenth modification;

FIG. 24 is a diagram illustrating a configuration of a system including an image processing device according to a second embodiment of the present disclosure;

FIG. 25 is a diagram illustrating a configuration of an image processing device according to a third embodiment of the present disclosure;

FIG. 26 is a diagram illustrating a configuration of a bioimaging apparatus according to a fourth embodiment of the present disclosure;

FIG. 27A is a diagram illustrating an image of a group of cells in an application of the bioimaging apparatus according to the fourth embodiment of the present disclosure;

FIG. 27B is a diagram illustrating a near-infrared image of the group of cells in FIG. 27A; and

FIG. 27C is a diagram illustrating a visible image of the group of cells in FIG. 27B, which is corrected by a color correction based on the near-infrared image.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to an embodiment of the present disclosure, a black image having a changed color can be restored.

Embodiments of an image processing device, a reading device, an image forming apparatus, a data management system, a bioimaging apparatus, and an image processing method will be described in detail below with reference to the accompanying drawings.

### First Embodiment

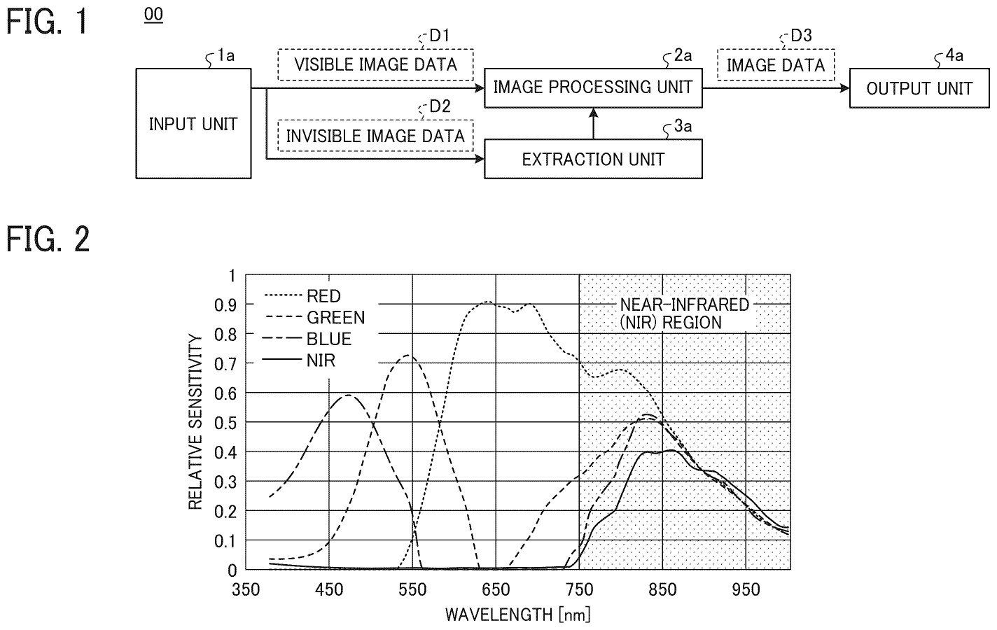

FIG. 1 is a diagram illustrating a configuration of an image processing device according to a first embodiment of the present disclosure. The image processing device 00 includes an input unit 1a, an image processing unit 2a, an extraction unit 3a, and an output unit 4a.

The input unit 1a inputs an object image. The object image includes visible image data D1 of the object and invisible image data D2 of the object. The extraction unit 3a extracts density information representing the absorptance of the invisible component at each position from the invisible image data D2 input from the input unit 1a.

The image processing unit 2a executes a color correction of at least one of saturation or brightness to the visible image data D1 at the same position of the visible image data D1 as the position of the invisible image data D2, based on the density information extracted by the extraction unit 3a, to generate image data D3. The output unit 4a outputs the image data D3. An output destination of the output unit 4a may be appropriately determined. The output destination is, for example, a display unit of the image processing device 00, or an external device connected to the image processing device 00.

As a first embodiment of the present disclosure, the image processing device 00 applied to a reading device will be described below. The overall configuration of the reading device will be described below, and a generation process of the image data D3 that displays a portion corresponding to a black character region of the visible image data D1 of the object in black in the reading device will be described below.

In the reading device, an imaging unit corresponds to the input unit 1a. Although the configuration of the reading device is described, the reading device may be any reading device as long as the reading device irradiates an object with light emitted from the light source and reads an object image by imaging the light from the object with the imaging unit.

The processing of the image processing unit 2a and the extraction unit 3a corresponds to processing for removing an imprint to an object image as described below. A part or all of this processing may be performed in the reading device, or may be performed by inputting an object image read by the reading device in an image processing device disposed separately from the reading device. In the case where the overall processing is performed by the image processing device, the image processing device may input the object image stored in the server or the memory. In an embodiment of the present disclosure, the image processing device is applied to a reading device, but the image processing device may be disposed separately from the reading device.

In an embodiment of the present disclosure, a reading device includes the image processing device, a visible light source to emit light having a visible wavelength range to the object, and an invisible light source to emit light having an invisible wavelength range to the object. The first sensor receives reflection light, having visible wavelength, reflected from the object and outputs the visible image data, and the second sensor receives reflection light, having an invisible wavelength, reflected from the object; and outputs the invisible image data.

The object may be referred to as a reading object below. The reading object includes a black character region in which a black character is printed, and a target to be removed (removing target) such as an imprint overlaps the black character region. For example, a paper document such as a certificate, a document, or a ledger sheet on which a seal is put are described, but a removing target is not limited to an imprint of the seal. Further, the reading object is not limited to a paper document.

The “visible image data” refers to image data read by a sensing device such as an image sensor having a sensitivity of light (visible light) emitted from a light source in a visible wavelength range. The “invisible image data” refers to image data read by a sensing device such as an image sensor having a sensitivity of light emitted from a light source in an invisible wavelength range such as infrared rays (including near-infrared rays) and ultraviolet rays. In the following description, near-infrared image data (simply referred to as a near-infrared image) serving as “invisible image data” will be described below, but the image is not limited to the near-infrared image. For example, near-infrared light is used as invisible light (see FIG. 2). As illustrated in FIG. 2, a typical silicon image sensor has sensitivity in the near-infrared region (approximately 750 nanometers (nm) to 1100 nm). Since a typical image sensor used in the related can be used, the configuration of an embodiment of the present disclosure becomes simple.

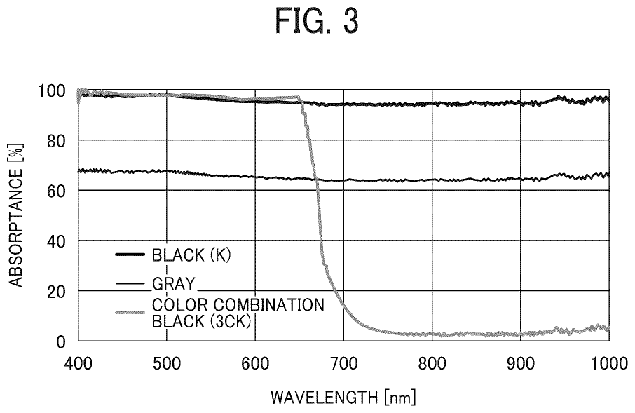

Black ink, black toner, or a black pencil used for a black character contains carbon. Carbon has features that absorb the light in the visible light range and the infrared light range. Thus, the black character can be read as black even in the visible light range and the infrared light range. By contrast, color ink and cyan-magenta-yellow (CMY) toner have features that transmit the light of the infrared range. FIG. 3 is a graph representing these features. The horizontal axis represents the wavelength of light, and the vertical axis represents the absorptance of the light. In FIG. 3, the black represents a color of a material containing carbon as described above, the gray represents a color printed by gray ink or black toner while thinning out, and color combination represents a color produced by combining CMY colors (referred to as color combination black below). Since the color combination black absorbs light in the visible region but transmits light in the near-infrared region, the paper printed with the color combination black can be read as white paper in the near-infrared region. A portion (pixel) having an absorptance of a predetermined value or more over a visible rage and an invisible range (near-infrared range) is defined as a “designated region”. For example, a color (pixel) having an absorptance of 40% or more is set as a designated region (i.e., black region).

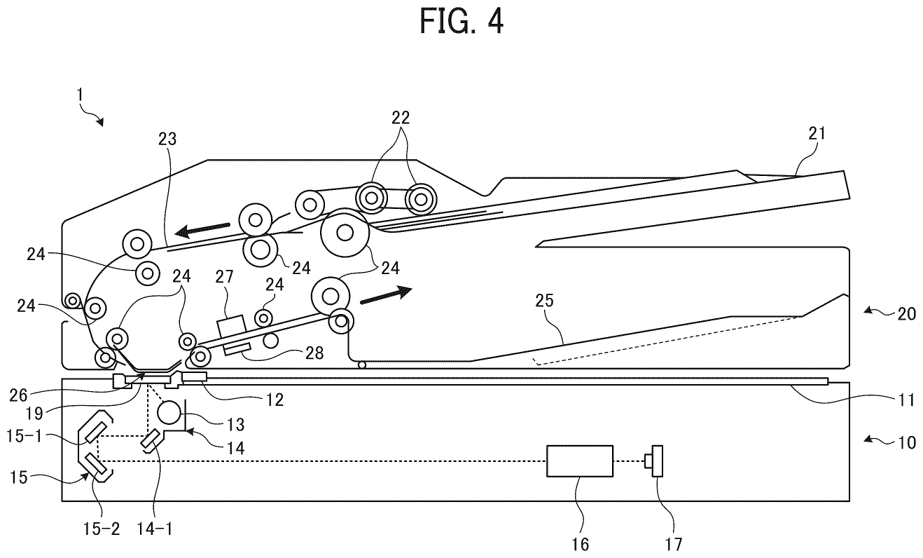

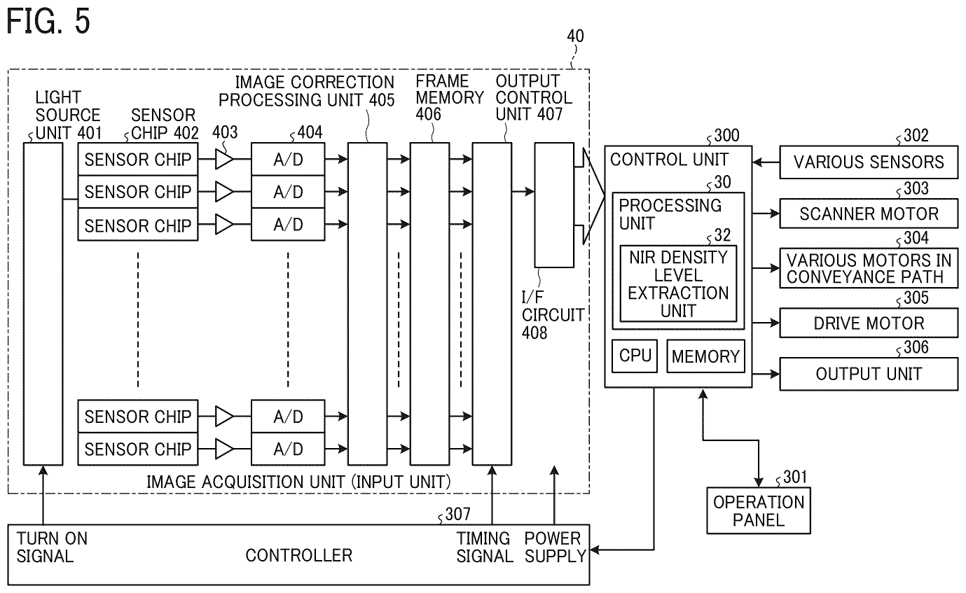

FIG. 4 is a diagram illustrating a reading device according to an embodiment of the present disclosure. The main body 10 of the reading device 1 includes a contact glass 11 on the upper surface of the main body 10, and an imaging unit is disposed in the main body 10. The main body 10, which may also be referred to as the reading device main body 10, includes a light source 13, a first carriage 14, a second carriage 15, a lens unit 16, and an image sensor 17. The first carriage 14 includes the light source 13 and a reflection mirror 14-1, and the second carriage 15 includes reflection mirrors 15-1 and 15-2. The reading device main body 10 also includes a control board. The control board is a control unit 300 illustrated in FIG. 5, and controls the overall reading device 1.

The control board sequentially reads the reflected light from the reading object placed on the contact glass 11 by the image sensor 17 by irradiating the reading object with the light from the light source 13 while moving the first carriage 14 and the second carriage 15. The light emitted from the light source 13 and reflected by the reading object is reflected by the mirror 14-1 of the first carriage 14 and the mirrors 15-1 and 15-2 of the second carriage 15 and enters the lens unit 16, and the light emitted from the lens unit 16 forms an image on the image sensor 17. The image sensor 17 receives the reflected light from the reading object and outputs an image signal. The image sensor 17 includes an image sensor such as a charge coupled device (CCD) or a complementary metal oxide semiconductor (CMOS), and serves as a reading unit that reads an image of the reading object.

The light source 13 includes a visible light source and a near-infrared light source. The image sensor 17 includes a first image sensor and a second image sensor. The first image sensor receives the reflected light from the reading object irradiated with the visible light. The second image sensor receives the reflected light from the reading object irradiated with the near-infrared light. An image received by irradiating the reading object with the visible light is referred to as a visible image, and an image received by irradiating the reading object with near-infrared light is referred to as a near-infrared image. Although the visible light source and the near-infrared light source are separately disposed as the light sources, the visible light source and the near-infrared light source may be one light source.

When both the first image sensor and the second image sensor can output a visible image and a near-infrared image, either the first image sensor or the second image sensor may be used or the first image sensor and the second image sensor may be separately disposed.

A white reference plate 12 is a component for a white correction.

The reading device 1 illustrated in FIG. 4 includes an automatic document feeder (ADF) 20. When one side of the ADF 20 is lifted upward, the ADF 20 is opened upward, and the face of the contact glass 11 is exposed. The reading object is set on the contact glass 11, the ADF 20 is lowered and pressed against the face of the contact glass 11 from the back face of the reading object by the user. When a scan start button is pressed, the first carriage 14 and the second carriage 15 are driven in the main scanning direction and the sub-scanning direction, and the overall reading object is read.

In addition to the method of reading the reading object by setting the reading object on the contact glass 11, the reading object can also be read by the following method. The ADF 20 can also read the reading object in a sheet-through method. In the ADF 20, a pickup roller 22 separates a bundle of reading objects from a tray 21 of the ADF 20 one by one, and reads one or both sides of the reading object that is conveyed through a conveyance path 23, and ejects the reading object to an ejection tray 25 under the control of various conveying rollers 24.

The reading object is read by the sheet-through method in the ADF 20 through a reading window 19. In the present embodiment, the first carriage 14 and the second carriage 15 are moved to a predetermined home position and stopped, and when a reading object passes between the reading window 19 and a background portion 26, the face of the reading object opposed to the reading window 19 is irradiated with the light emitted from the light source 13 and an image is read. The reading window 19 is a reading window having a slit shape disposed in a part of the contact glass 11. The background portion 26 is a background component.

When the ADF 20 performs double-sided reading of the reading object, the back side of the reading object is read by a reading module 27 of another reader disposed on the back side of the reading object after the reading object has passed the reading window 19. The reading module 27 includes an irradiation unit including a light source and a contact type image sensor as a second reading unit, and reads by the contact type image sensor, the reflected light from the second face irradiated with light of the irradiation unit. The light source may also include a visible light source and a near-infrared light source so that a visible image and a near-infrared image can be read. The background component 28 is a density reference component.

The configuration of the control block of reading device 1 will be described below.

FIG. 5 is a block diagram of the reading device according to an embodiment of the present disclosure. As illustrated in FIG. 5, the reading device 1 includes a control unit 300, an operation panel 301, various sensors 302, a scanner motor 303, various motors 304 in the conveyance path, a drive motor 305, an output unit 306, and an imaging unit 40. In addition, various control objects are connected. The various sensors 302 are sensors that detect the reading object. The scanner motor 303 is a motor that drives the first carriage 14 and the second carriage 15 of the main body 10. The various motors 304 in the conveyance path are various motors disposed in the ADF 20. The output unit 306 corresponds to an output interface for the output unit 4a to output the image data to an external device. The output interface may be an interface such as a universal serial bus (USB) or a communication interface connected to a network.

In an embodiment of the present disclosure, in the image processing device, the circuitry further outputs the image data to an external device.

The operation panel 301 is, for example, a liquid crystal display device of touch screen type. The operation panel 301 accepts input operations such as various settings and reading execution (scan start) from the user via operation buttons or touch inputs, and sends corresponding operation signals to the control unit 300. The operation panel 301 displays various display information from the control unit 300 on the display screen. For example, the operation panel 301 includes various setting buttons for removing an imprint of a seal pressed by the user on an object, and instructs the control unit 300 to make settings when an input operation of the setting buttons is performed. On the setting screen of the display screen, a selection whether to remove the imprint may be performed. Further, a setting in which the processing of removing the imprint is always executed when the button for executing the scanning is operated may be applied. Various data used for removing the imprint may be stored in an external memory or output to an external device.

The imaging unit 40 corresponds to the input unit 1a. The imaging unit 40 includes a light source unit 401, a sensor chip 402, an amplifier 403, an analog-to-digital (A/D) converter 404, an image correction processing unit 405, a frame memory 406, an output control unit 407, and an interface (I/F) circuit 408, and an image read from the reading object is output from the output control unit 407 to the control unit 300 via the I/F circuit 408 for each frame. Each sensor chip 402 is a pixel sensor of the image sensor 17. The light source unit 401 is a light source 13.

In an embodiment of the present disclosure, a first sensor having a sensitivity of a visible wavelength range, to read visible image data of an object, a second sensor having a sensitivity of an invisible wavelength range to read invisible image data of the object, and circuitry that performs a color correction to correct a color of at least one of saturation or brightness to the visible image data based on the invisible image data at a same position with a position of the visible image data to generate image data.

The imaging unit 40 is driven by a controller 307. For example, the imaging unit 40 turns on the light source unit 401 based on the lighting signal from the controller 307, and irradiates the reading object with the visible light and the near-infrared light at a predetermined timing. The imaging unit 40 converts the light, which is from the reading object, imaged on the sensor face of the image sensor 17 into an electric signal by each sensor chip 402 and outputs the signal.

The imaging unit 40 amplifies the pixel signal output from each sensor chip 402 by the amplifier 403, converts the analog signal into the digital signal by the A/D converter 404, and outputs the level signal of the pixel. The image correction processing unit 405 performs image correction processing to the output signal from each pixel. For example, the image correction processing unit 405 performs shading correction to the output signal from each pixel.

After the image correction processing, each data is accumulated in the frame memory 406, and the accumulated read image is transferred to the control unit 300 via the output control unit 407 and the I/F circuit 408.

The control unit 300 includes a central processing unit (CPU), and a memory, and the CPU controls the overall device to perform a reading operation to a reading object and processing such as imprint removing to a read image obtained by the reading operation.

The control unit 300 includes a processing unit 30 and a near-infrared (NIR) density level extraction unit 32. The processing unit 30 and the NIR density level extraction unit 32 can be implemented by a functional unit that is implemented by the CPU executing a predetermined program. In addition, the processing unit 30 and the NIR density level extraction unit 32 can be implemented by hardware such as an application specific integrated circuit (ASIC).

In an embodiment of the present disclosure, in the image processing device, the circuitry further extracts density information, expressing an absorptance of an invisible component at each position, from the invisible image data and performs the color correction of at least one of the saturation or the brightness to the invisible image data at the same position with the position of the visible image data based on the density information of the invisible image data.

### Removal of Imprint

Removal of an imprint will be described in detail below. With an example in which a reading object is a document, a description is given below of a configuration or method of removing an imprint of a seal on a read image formed by scanning the document with a designated color removal function of removing a predetermined color. The black ink, black toner, or a black pencil used for printing or writing black characters contains carbon. Carbon has a feature of absorbing light in the infrared range. By contrast, the color ink and the CMY color toner have features that transmit the light of the infrared range. Colors other than black, such as the color ink and the CMY color toner, may be referred to as “color ***”, such as color ink and color toner.

Thus, when a near-infrared image is read by irradiating the reading object with a near-infrared light, the near-infrared light is transmitted through a portion formed by color components on a paper medium, and the near-infrared light is reflected by the paper medium. As a result, the paper medium is read as a bright color such as white having a large luminance value.

By contrast, in a black character printing region, both the visible light and the near-infrared light are absorbed. Since the black character region absorbs the near infrared light, the amount of reflected light is small, and the black character region is read as black having a small luminance value. In an overlap portion of the black character region that an imprint overlaps, the near-infrared light is transmitted through the imprint. However, since the near-infrared light is absorbed in the overlap portion of the black character region that the imprint overlaps, the color of the overlap portion is read as black in the near-infrared image even if the color of the overlap portion is reddish under visible light. In addition, a non-overlap portion of the black character region that the imprint does not overlap is read as black even under the visible light.

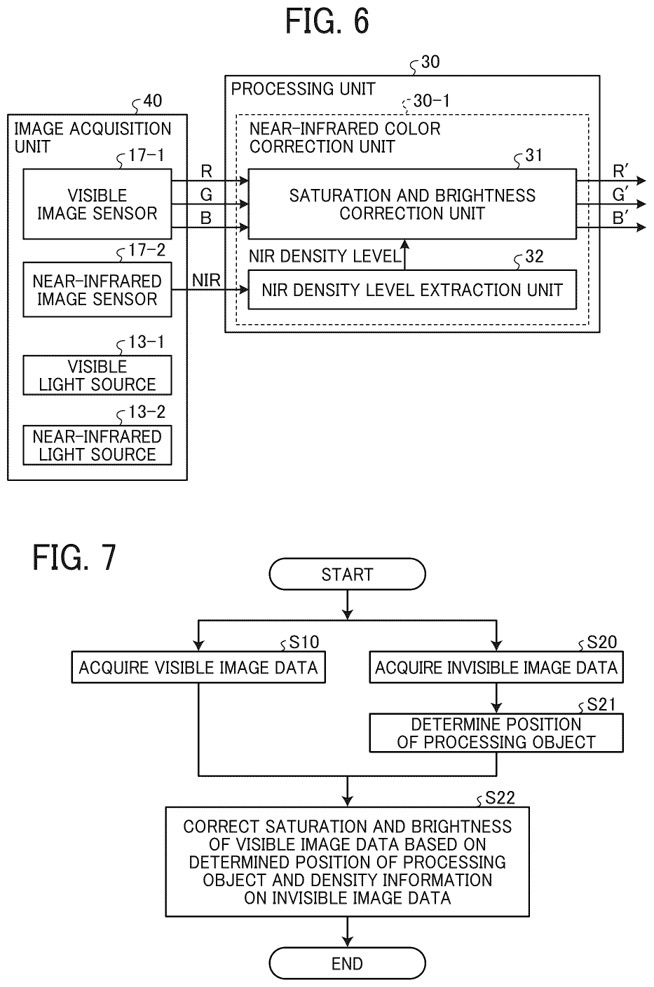

FIG. 6 is a diagram illustrating a schematic configuration for correcting a black character in removing the imprint. The imaging unit 40 includes the visible light source 13-1 and the visible image sensor 17-1 illustrated in FIG. 5, and the near-infrared light source 13-2 and the near-infrared image sensor 17-2. The imaging unit 40 irradiates the reading object with the light emitted from the visible light source 13-1, receives the reflected light reflected from the reading object by the visible image sensor 17-1, and outputs a visible image (e.g., an RGB image of red (R), green (G), blue (B) components). Further, the imaging unit 40 irradiates the same reading object with the light emitted from the near-infrared light source 13-2, reads the reflected light reflected from the object by the near-infrared image sensor 17-2, and outputs a near-infrared image (NIR image). The imaging unit 40 can simultaneously read both the visible image and the near-infrared image from the same reading object. When the reading object for the visible light and the reading object for the near-infrared light are the same, the imaging unit 40 does not need to read both the visible image and the near-infrared image at the same time, and if the position of the reading object for the visible light and the position of the reading object for the near-infrared light are coincident with each other, the timings of reading the reading object may be different from each other.

The processing unit 30 includes a saturation and brightness correction unit 31 and an NIR density level extraction unit 32. The saturation and brightness correction unit 31 and the NIR density level extraction unit 32 are collectively referred to as a near-infrared color correction unit 30-1. In this configuration, the saturation and brightness correction unit 31 of the processing unit 30 corresponds to the image processing unit 2a (see FIG. 1), and the NIR density level extraction unit 32 corresponds to the extraction unit 3a (see FIG. 1).

The near-infrared color correction unit 30-1 receives the visible image and the near-infrared image taken by the imaging unit 40. The near-infrared color correction unit 30-1 extracts a density level as a carbon content in the invisible signal from the input invisible image, and performs the correction processing of saturation and brightness of color information to the same position of the visual image as the position of the invisible image using the extracted density level.

In an embodiment of the present disclosure, in the image processing device, the circuitry further uses a carbon content as the density information of the invisible image data.

More specifically, the NIR density level extraction unit 32 determines the NIR density level in the invisible signal from the input invisible image (near-infrared (NIR) image), and outputs the determined NIR density level to the saturation and brightness correction unit 31. The saturation and brightness correction unit 31 uses the NIR density level determined by the NIR density level extraction unit 32 to perform the correction processing of at least one of saturation or brightness of the color information to the same position of the visible image (RGB image) as the position of the NIR image. The saturation and brightness correction unit 31 outputs a corrected R′G′B′ image (i.e., an image of corrected red (R′), green (G′), and blue (B′) components) to the following processing. The R′G′B′ image corresponds to a first processed image. The saturation and brightness correction unit 31 may correct either saturation or brightness, or both saturation and brightness as the saturation and brightness correction.

The RGB image includes an R image, a G image, and a B image, and the saturation and brightness correction unit 31 corrects saturation and brightness of target color pixels of the R image, the G image, and the B image. The corrected R′G′B′ image includes a corrected R′ image, a corrected G′ image, and a corrected B′ image.

For example, the saturation and brightness correction unit 31 performs at least one of lowering saturation or lowering brightness. Typically, ink has a feature of transmitting light having a near-infrared wavelength. The saturation and brightness correction unit 31 uses not only the appearance color but also the black component included in the near-infrared component and adjusts saturation and brightness so as to be lower. Thus, as an advantage of detecting the near-infrared component, the changed color of a black character caused by color overlapping can be corrected.

In an embodiment of the present disclosure, in the image processing device, the circuitry performs at least one of lowering the saturation or lowering the brightness to the visible image data.

FIG. 7 is a flowchart of image processing according to the first embodiment of the present disclosure. The input unit 1a or the imaging unit 40 acquires visible image data of a reading object by the visible image sensor 17-1 (step S10), and acquires invisible image data of an object by the near-infrared image sensor 17-2 (step S20). As described above, when the reading object of the visible image and the reading object of the invisible image are the same, the imaging unit 40 does not need to read the visible image data and the invisible image data at the same time, and may acquire the visible image data and the invisible image data at different timings as long as the position of the reading object and the position of the object are coincident with each other.

The extraction unit 3a or the NIR density level extraction unit 32 extracts density information of the acquired invisible image and determines a target position of the correction processing (processing target position) based on the extracted density information (step S21).

The image processing unit 2a or the saturation and brightness correction unit 31 uses the determined processing target position and the density information of the acquired invisible image to generate image data (step S22). The image data is generated by executing a color correction of at least one of saturation or brightness to the same position of the visible image data as the position of the NIR image data.

In an embodiment of the present disclosure, an image processing method includes causing a first sensor having a first sensitivity in a visible wavelength range to acquire visible image data of an object, causing a second sensor having a second sensitivity in an invisible wavelength range to acquire invisible image data of the object, and performing a color correction to correct a color of at least one of saturation or brightness to the visible image data based on the invisible image data at a same position with a position of the visible image data to generate image data.

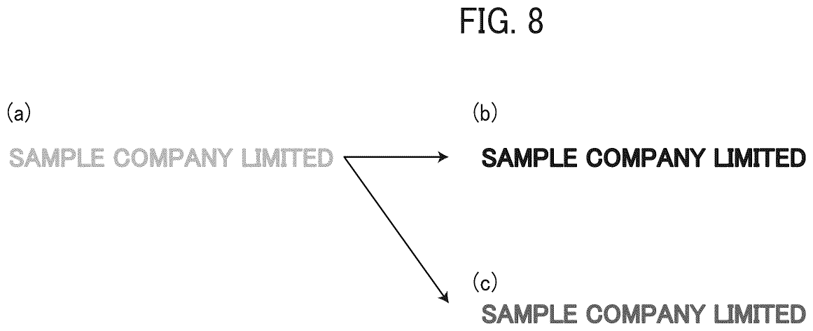

FIGS. 8A to 8C are diagrams illustrating effects of switching the correction level of lowering saturation or lowering brightness depending on the NIR density level. As illustrated in FIGS. 8A to 8C, when not only a black character region but also a turbid color with low saturation and low brightness is expressed, there is a case where colors including the black (K) color are used. In such a color, the light of the invisible image (NIR image) is absorbed, and the invisible image (NIR image) is displayed in gray to some extent. If all regions having light absorption in the invisible image (NIR image) are set as black character regions and the processing of uniformly approximating all the regions to the black character is performed, the turbid color (also color of ink or matt black) is greatly desaturated, the color component is lost, and the image quality greatly differs from the original image. Thus, since the level of saturation and brightness adjustment can be switched depending on the NIR density level, the original color portion can be adjusted without greatly changing the original color while the black character having a changed color is corrected so as to come close to the original black color.

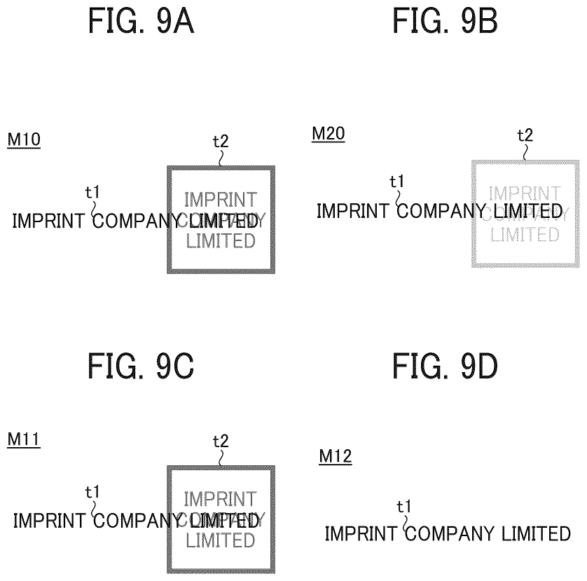

FIGS. 9A to 9C are diagrams illustrating images to be processed by the near-infrared color correction unit 30-1. As the reading object, for example, a document in which a red color imprint overlaps a part of black characters t1 “IMPRINT COMPANY LIMITED” is used.

FIG. 9A is a diagram illustrating a visible image M10 to be input in the near-infrared color correction unit 30-1. In the visible image M10, the state is the same as when the original document is viewed by human eyes under visible light. In other words, an imprint t2 having a red color remains overlapping a part of black characters t1 of “IMPRINT COMPANY LIMITED”, and the part of the black characters t1 that the imprint t2 overlaps is tinged with red by the imprint t2. In this state, even if the OCR processing is performed, all characters in the black characters t1 of “IMPRINT COMPANY LIMITED” cannot be identified.

FIG. 9B is a diagram illustrating a near-infrared image M20 to be input in the near-infrared color correction unit 30-1. In the near-infrared image M20, all of the black characters t1 of “IMPRINT COMPANY LIMITED” that are same with those of the visible image M10 emerges. A part of the black characters that the imprint t2 overlaps emerges as same with other parts of the black characters by near-infrared light irradiation. The NIR density level extraction unit 32 determines the NIR density level of a part of the black characters t1 of “IMPRINT COMPANY LIMITED” presumed to be a black character region from the input invisible image (NIR image), and outputs the determined NIR density level to the saturation and brightness correction unit 31.

FIG. 9C is a diagram illustrating an image after the saturation and brightness correction unit 31 has performed a color correction of saturation or brightness to the visible image at the same position of the visible image that is a part of the black characters t1 of “IMPRINT COMPANY LIMITED”, of which the NIR density level has been determined, with the position of the NIR image. In other words, the image is the first processed image M11. In the visible image M10, the part of the black characters t1 of “IMPRINT COMPANY LIMITED” that the imprint t2 overlaps is tinged with read. However, since the color correction processing is performed, the part of the black characters tinged with red become black. Further, as in the first processed image M11, other parts of the black characters t1 of “IMPRINT COMPANY LIMITED” that does not overlap the imprint t2 are also restored to black without interruption from the part that overlaps the imprint t2.

FIG. 9D is a diagram illustrating an image M12 after the imprint has been removed in the case where a predetermined color has been removed using the first processed image M11. The imprint t2 is removed by removing the red color of the imprint t2. However, the black characters t1 of “IMPRINT COMPANY LIMITED” remain clear without any blur or defect.

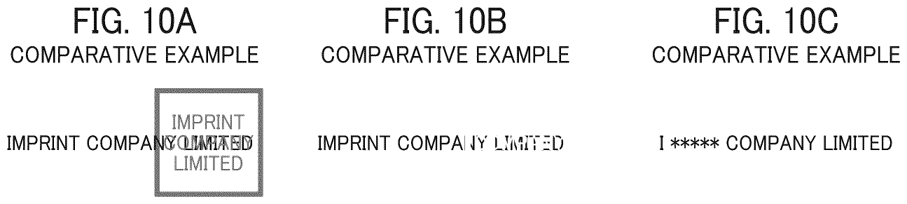

FIGS. 10A to 10C are diagrams illustrating images in which a predetermined color is removed by a typical method in the related art as comparative examples. As illustrated in FIGS. 10A to 10C, in the case where a predetermined color is removed by a typical method, a part of the black characters t1 of “IMPRINT COMPANY LIMITED” has blur or defect. As a result, the OCR processing has a difficulty in recognizing the part of the black characters t1.

As described above, in an embodiment of the present disclosure, the saturation and brightness correction unit 31 and the NIR density level extraction unit 32 are disposed, and the image data performed by a color correction of at least one of saturation or brightness is generated based on the same position of the visible image with the position of the invisible image (near-infrared image).

Accordingly, since the black character (black image) having a changed color caused by overlapping the imprint is also restored to black, the blur and loss of the black character can be prevented even when the imprint is removed by removing a predetermined color in the following processing. As a result, the OCR recognition rate can be increased.

### First Modification

A case where an RGB image processed by the saturation and brightness correction is output to an external device disposed outside the reading device 1 will be described below. Although the same applies to other embodiments and modifications described below, the description overlapping the above-described embodiment will be omitted as appropriate, and the description will be mainly given of the different portions.

The connection between the reading device 1 and the external device may be a wired connection or a wireless connection. The reading device 1 and the external device may be connected to each other with a connection cable such as a USB, or may be connected to each other through a communication network by a communication interface.

The external device is, for example, an information processing device such as a user personal computer (PC), or a server device. The CPU executes a predetermined program and performs, for example, processing of removing an imprint from an RGB image processed by saturation and brightness correction or the OCR processing. The signal is output to the external device from the output unit 306 (see FIG. 5).

In an embodiment of the present disclosure, in the image processing device, the circuitry further outputs the visible image data of the object to the external device.

In an embodiment of the present disclosure, the image processing device, the circuitry further generates color-removed image data by removing a predetermined color from the image data, generates monochromatized image data by monochromatizing the color-removed image data, and outputs the monochromatized image data to the external device.

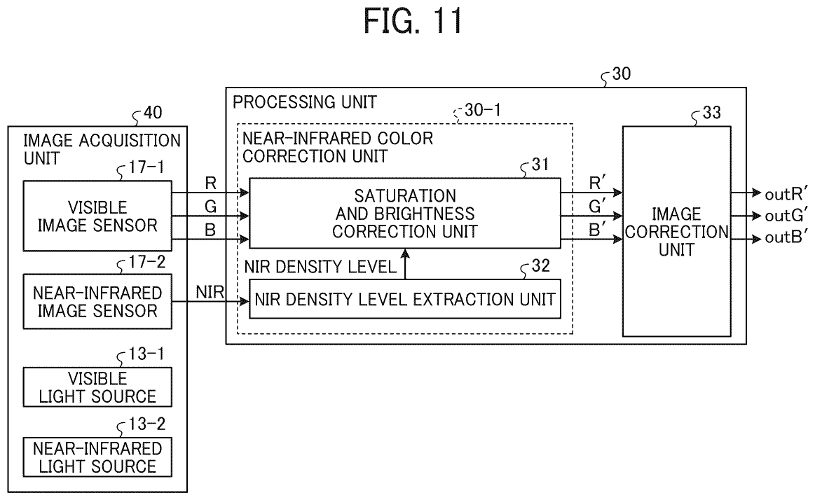

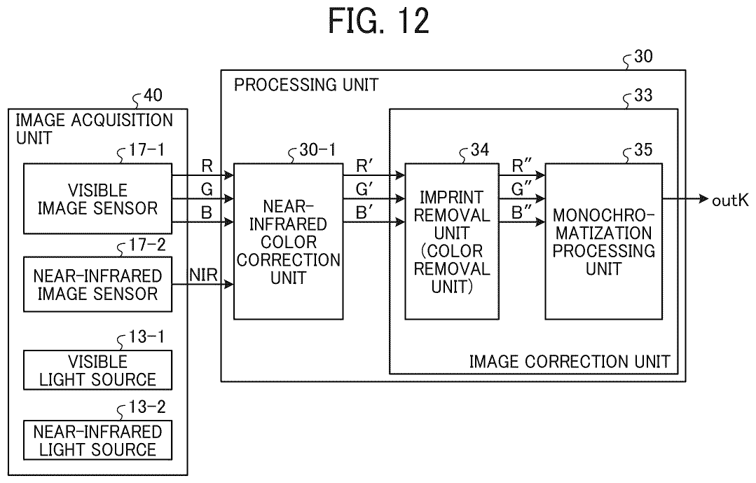

FIG. 11 is a diagram illustrating a configuration of a reading device according to a first modification of the above-described embodiment. An image correction unit 33 is disposed in the processing unit 30. The image correction unit 33 performs filtering or color correction to the R′G′B′ image output from the near-infrared color correction unit 30-1, and outputs the outR′G′B′ image to the external device. The image output to the external device is data before the imprint is removed by removing a predetermined color.

As described above, in the configuration of the first modification, the reading device 1 can output the outR′G′B′ image that can be handled in the same manner as a typical RGB scanner image. Since the outR′G′B′ image processed by the saturation and brightness correction to a part of the black characters that overlaps the imprint, even when other processing is performed in the following processing, the external device in the following processing can handle the image in the same manner as the RGB scanner image such as a document image in which the imprint is not originally printed. The outR′G′B′ image can be used as an image for storage because the outR′G′B′ image is output with a quality equivalent to that of a typical RGB scanner image in appearance.

In the case where the OCR processing is performed by an external device as post-processing, since the saturation and brightness correction is performed to a part of the black character that overlaps the imprint, even after the imprint is removed by removing the predetermined color, the black characters are less likely to have blur or defect. Thus, the erroneous recognition in the OCR processing can be prevented.

### Second Modification

A case where an RGB image processed by the saturation and brightness correction is output outside as an image for OCR processing will be described below. FIG. 12 is a diagram illustrating a configuration of a reading device according to a second modification of the above-described embodiment.

As illustrated in FIG. 12, the image correction unit 33 includes an imprint removal unit 34 and a monochromatization processing unit 35. The imprint removal unit 34 removes a predetermined color from the R′G′B′ image processed by the saturation and brightness correction to remove the imprint from the R′G′B′ image. Thus, an imprint-removed R″G″B″ image of predetermined color removed red (R″), predetermined color removed green (G″), and predetermined color removed blue (B″) components are obtained. The monochromatization processing unit 35 performs K monochromatization processing to the imprint-removed R″G″B″ image such that the OCR processing easily recognizes the characters. The image after the K monochromatization processing is output from the image correction unit 33 to the outside. The image after the monochromatization processing corresponds to the “second processed image”.

In the configuration of the second modification, the imprint can be removed using optimum removal parameters to the R′G′B′ image processed by the saturation and brightness correction in the same system. Thus, for example, a removal parameter that is easy to determine color can be used on the assumption that black characters have processed by the saturation and brightness correction, and a slightly dull imprint can be set as a removal target. Accordingly, in the configuration of the second modification, the accuracy of removing the imprint can be increased.

### Third Modification

When a ledger sheet is read in the OCR processing, there is a case where the original ledger sheet is stored as evidence. In such a case, it is required to retain information such as an imprint stamped on the ledger sheet. An image that has processed so as to be optimal for the OCR processing is not suitable for storing as evidence because unnecessary information other than characters has been removed.

In the third modification, a configuration that can output an OCR image monochromatized specially for the OCR processing described in the second modification and an original image unprocessed for the OCR processing will be described below.

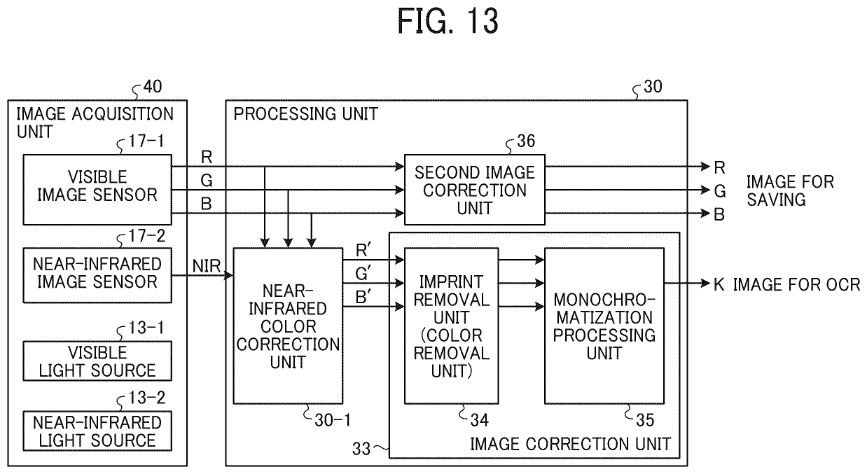

FIG. 13 is a diagram illustrating a configuration of a reading device according to a third modification of the present disclosure. As illustrated in FIG. 13, an RGB image output from the visible image sensor 17-1 is output to both a processing unit for outputting a storage image and a processing unit for outputting an OCR image. The processing unit for outputting the storage image corresponds to a second image processing unit 36 in FIG. 13. The second image processing unit 36 performs image correction processing for storage to the RGB image output from the visible image sensor 17-1, and outputs an RGB image for storage. The configuration of the processing unit for outputting the OCR image is the same as that of the near-infrared color correction unit 30-1 and the image correction unit 33 illustrated in FIG. 12, and thus the description thereof is omitted.

In the configuration of the third modification, the storage image and the OCR image are output together for one reading object in one reading. Accordingly, both the storage image and the OCR image can be obtained by the user through, for example, a PC, and a time to obtain the storage image and the OCR image individually can be omitted.

In FIG. 13, the configuration of the near-infrared color correction unit 30-1 and the image correction unit 33 in FIG. 12 is applied to the processing unit for outputting the OCR image, but the configuration is not limited thereto. For example, the outR′G′B′ image may be output in the configuration illustrated in FIG. 11. The outR′G′B′ image is an image processed by the saturation and brightness correction, but the predetermined color has not removed from the image.

### Example of Third Modification

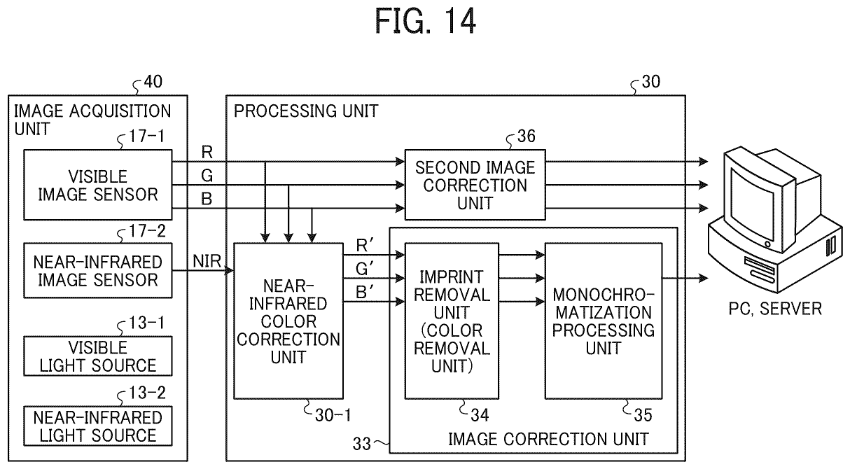

An example of the third modification will be described below. FIG. 14 is a diagram illustrating a data management system to which the configuration of the device illustrated in FIG. 13 is applied. In the data management system, a PC or a sever includes a memory and saves storage image data and OCR image data sent from the processing unit 30 as one set of data. The storage image data and the OCR image data are managed in a common storage device with names associated with each other so that the relation between the storage image data and the OCR image data can be known. Since the data management system according to the third modification is used, the loss of the original data of the OCR image data can be prevented. Further, the storage image data and the OCR image data are easily managed in common.

In an embodiment of the present disclosure, a data management system includes the image processing device and an information processing device to link the visible image data sent from the image processing device and the image data generated by the circuitry, to manage the visible image data and the image data.

### Forth Modification

As a fourth modification, a determination method in the NIR density level extraction unit in the case where an imprint slightly emerges in a near-infrared image will be described below.

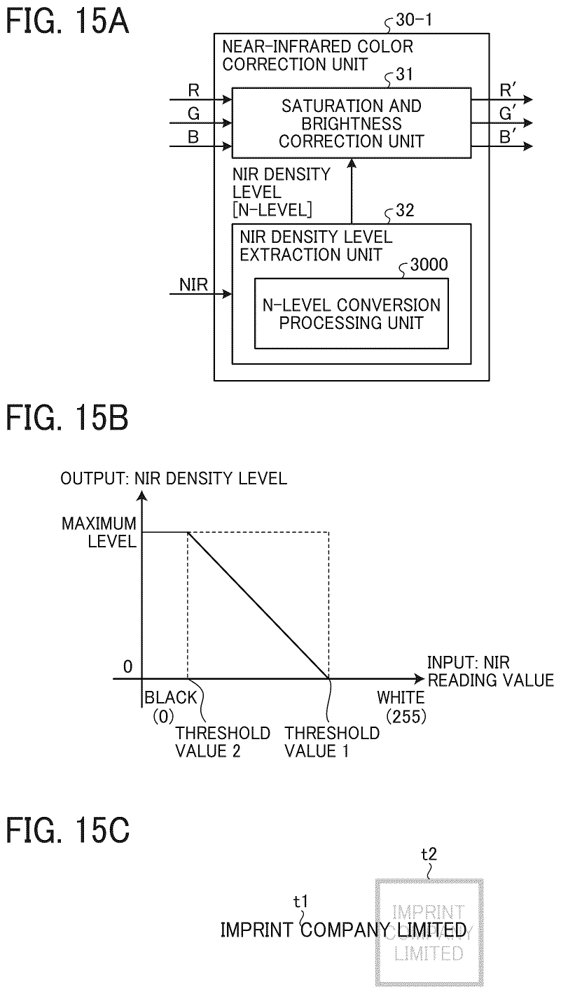

FIGS. 15A to 15C are diagrams illustrating an NIR density level extraction unit 32, processing, and a near-infrared image according to the fourth modification. As illustrated in FIG. 15A, the NIR density level extraction unit 32 includes an N-level conversion processing unit 3000. FIG. 15B is a diagram illustrating N-level conversion processing in the N-level conversion processing unit 3000. FIG. 15C is a diagram illustrating a near-infrared image in which an imprint t2 slightly emerges.

As illustrated in FIG. 15A, the N-level conversion processing is used as a method of the NIR density level extraction. The N-level conversion processing in the N-level conversion processing unit 3000 is specifically described in FIG. 15B. As illustrated in FIG. 15B, a pixel value of the input NIR image is compared with a threshold value 1, and if the pixel value is at a side of black from the threshold value 1, the NIR density level is a target of extraction. On the other hand, if the pixel value of the input NIR image is at a side of white from the threshold value 1, the region is set as a non-extraction region, and the NIR density level is set to 0. If the NIR reading value is at a side of black from the threshold value 2, the NIR density level is set to a maximum density level, and a density level between the threshold value 1 and the threshold value 2 is changed step by step.

The resolution of the output NIR density level may be the same as that of the input NIR reading value, or may be lowered to, for example, a resolution of 32 steps (i.e., 0 to 31) with respect to the resolution of 256 steps (i.e., 0 to 255) of the input NIR reading value. A configuration that outputs the resolution of 32 steps of the output NIR density level may be used.

The reason for setting the threshold value 1 will be described below. As illustrated in FIG. 15C, the imprint t2 slightly emerges in an NIR image. As described above, since the black characters absorb the near-infrared light, and the near-infrared sensor receives less amount of the near-infrared light, the black characters are expressed by black. On the other hand, since a color part such as the imprint t2 absorbs less near-infrared light, but has a feature to absorb a small amount of near-infrared light, there is a case where the imprint t2 is expressed in light gray as illustrated in FIG. 15C. The threshold value 1 that determines a minimum NIR density level is set to remove such an undesired part.

The NIR density level extraction unit 32 outputs the result of the N-level conversion processing described above to the saturation and brightness correction unit 31.

As described above, the NIR density level extraction unit 32 outputs the NIR density level, and thus color correction depending on the NIR density information can be performed.

### Fifth Modification

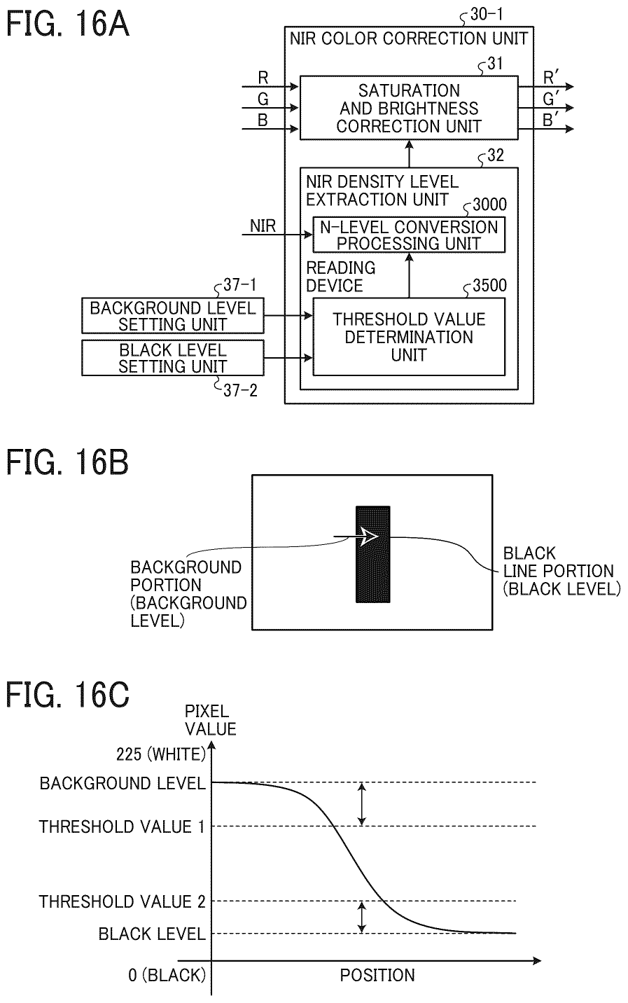

FIGS. 16A to 16C are configurations that determine a threshold value in the NIR density level extraction unit 32 according to a fifth modification.

FIGS. 16A to 16C are diagrams illustrating an NIR density level extraction unit 32, a reading image, and a threshold value according to the fifth modification. FIG. 16A is a diagram illustrating a configuration that determines a threshold value in the NIR density level extraction unit 32. FIG. 16B is a diagram illustrating an NIR reading image. FIG. 16C is a graph of a relation between a change in pixel value of an edge portion and a threshold value.

The reading device 1 reads both the RGB image and the NIR image by the same optical system (lens and mirror). Thus, when the adjustments to the RGB image and the NIR image are performed depending on the image quality of the RGB image, the near-infrared image becomes an image with stronger blur than the RGB image. Accordingly, unlike the RGB image, the near-infrared image may not have a sufficiently low value of the black level. Further, the near-infrared image may not have a sufficiently high value of the white level with respect to the background level because the background level is likely to be affected by show-through. Thus, it is necessary to determine the threshold value of the NIR density level extraction in consideration of the black level and the white level.

As illustrated in FIG. 16A, the reading device 1 includes the background level setting unit 37-1, the black level setting unit 37-2, and the threshold value determination unit 3500.

The background level setting unit 37-1 sets a background level. The black level setting unit 37-2 sets the black level of the black character. The threshold value determination unit 3500 determines a threshold value using the background level set by the background level setting unit 37-1 and the black level set by the black level setting unit 37-2. The N-level conversion processing unit 3000 performs the N-level conversion processing using the threshold value.

In an embodiment of the present disclosure, in the image processing device, the circuitry further detects a background level of the visible image data of the object, detects a black level of the visible image data of the object, and determines a threshold value corresponding to each region of the visible image data of the object based on the background level and the black level.

As illustrated in FIG. 16C, the system holds setting values of the background level and the black level as setting values and design values in the user interface (UI) in advance, and the threshold value determination unit 3500 determines the threshold values (threshold value 1 and threshold value 2) based on the setting values of the background level setting unit 37-1 and the black level setting unit 37-2.

Accordingly, the optimum NIR density level can be determined after grasping a conceivable range of these values from the background level and the black level, and thus, the NIR density level with higher accuracy can be extracted. As a result, the correction with higher accuracy can be performed.

### Sixth Modification

As a sixth modification, the second modification that determines a threshold value in the NIR density level extraction unit. In the fifth modification, the threshold value is determined by the setting value or the design value set via the UI. However, the background level and the black level of the characters differ depending on the input image. Even in a single document, the color and darkness of the background and darkness of the black character may vary depending on the position of the document. There is a case where the background level is darker than an expected level and the character is detected as a black character when the predetermined value is used. In the sixth modification, a configuration that a system automatically detects the background level and the black level from an image and determines the threshold value will be described below.

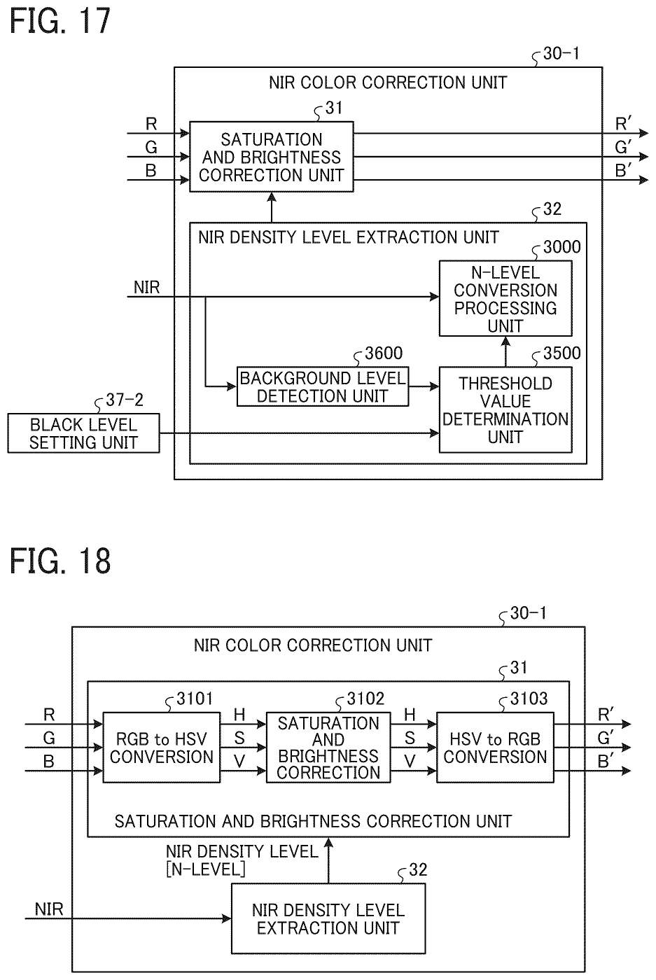

FIG. 17 is a diagram illustrating a configuration of an NIR density level extraction unit 32 according to a sixth modification. As illustrated in FIG. 17, the near-infrared color correction unit 30-1 includes a background level detection unit 3600 in the NIR density level extraction unit 32 in place of the background level setting unit 37-1 in FIG. 16A.

The background level detection unit 3600 sets a target pixel in an NIR image, refers to a peripheral pixel in any region, and detects a background level in the vicinity of the target pixel.

The black level setting unit 37-2 detects the black level of the black character. The threshold value determination unit 3500 determines a threshold value using the background level detected by the background level detection unit 3600 and the black level set by the black level setting unit 37-2. The N-level conversion processing unit 3000 performs the N-level conversion processing using the threshold value.

In this configuration, since the background level is detected for each input image, the background level varies depending on the input image. Even in a single document, the color and darkness of the background and may vary depending on the position of the document. There is a case where the background level is darker than an expected level and the character is detected as a black character when the predetermined value is used. Thus, in this configuration, the background level can be automatically detected from an image.

The background level detection unit 3600 refers to a peripheral pixel in any range (e.g., 5 millimeters (mm)×5 mm in the periphery) with respect to the target pixel, and detects the background level in the vicinity of the target pixel. The threshold value determination unit 3500 calculates a threshold value using the background level detected by the background level detection unit 3600 and the value set by the black level setting unit 37-2.

The N-level conversion processing unit 3000 performs N-level conversion processing using the threshold value calculated in the threshold value determination unit 3500. Accordingly, the N-level conversion processing can be performed with an optimum threshold value depending on the features of each region of the input image, and the NIR density level with high accuracy can be extracted.

In an embodiment of the present disclosure, in the image processing, the circuitry further performs N-level conversion processing to the invisible image data to obtain the density information, and outputs the density information obtained by the N-level conversion processing.

In an embodiment of the present disclosure, in the image processing device, the circuitry further determines a threshold value based on a predetermined background level and a predetermined black level and performs the N-level conversion processing to the invisible image data based on the threshold value.

In the sixth modification, the black level is set by the external setting. However, the black level may be automatically detected in the vicinity of the target pixel by referring to the peripheral pixel in any range with respect to the target pixel, as in the case of the background level detection.

### Seventh Modification

As a seventh modification, an example of processing by the saturation and brightness correction unit 31 will be described.

FIG. 18 is a diagram illustrating processing in the saturation and brightness correction unit 31 according to the seventh modification. As illustrated in FIG. 18, the saturation and brightness correction unit 31 performs RGB-to-HSV conversion 3101, saturation and brightness correction processing 3102, and HSV-to-RGB conversion 3103. The RGB-to-HSV conversion 3101 corresponds to “the saturation and brightness conversion unit”, and the HSV-to-RGB conversion unit 3103 corresponds to the “RGB conversion unit”.

In the RGB-to-HSV conversion unit 3101, an input RGB image is converted into an HSV signal (hue, saturation, and brightness signal).

In the saturation and brightness correction processing 3102, the saturation and brightness correction processing that performs a correction of lowering saturation or lowering brightness depending on the input NIR density level is performed to the input HSV signal. For example, the target position of the correction processing is determined based on the NIR density level, and the correction processing corresponding to the NIR density level is performed on the HSV signal at the same position as the target position.

In the HSV-to-RGB conversion unit 3103, an inverse conversion that returns the HSV signal after the saturation and brightness correction processing into the RGB image, and the R′G′B′ image after the saturation and brightness correction processing is output in the following processing.

In an embodiment of the present disclosure, the image processing device, the circuitry further converts red-green-blue image data into a hue-saturation-brightness signal, performs the color correction of at least one of the saturation or the brightness to the hue-saturation-brightness signal at the same position with the position of the invisible image data based on the density information of the invisible image data, and reconvert the hue-saturation-brightness signal after the color correction into the red-green-blue image data.

### Calculation Example

An example of the calculation processing of the RGB-to-HSV conversion 3101 will be described below. More specifically, the conversion coefficients of saturation and brightness are generated by the NIR density level. Since each of saturation and brightness has one-dimensional lookup table (LUT), a saturation adjustment coefficient for the input NIR density level and saturation conversion and a brightness adjustment coefficient for the brightness correction can be adjusted. Saturation adjustment coefficient=Saturation adjustment table [NIR density level] Output saturation signal=Input saturation signal value×Saturation adjustment coefficient Brightness adjustment coefficient=Brightness adjustment table [NIR density level] Output saturation signal=Input brightness signal value×Saturation adjustment coefficient.

In an embodiment of the present disclosure, in the image processing device, the circuitry further determines a saturation adjustment coefficient by a one-dimensional lookup table of a saturation adjustment coefficient and a brightness adjustment coefficient by a one-dimensional lookup table of the brightness with respect to the density information of the invisible image data and performs the color correction based on the saturation adjustment coefficient and the brightness adjustment coefficient.

In this processing, since once the RGB image is converted into a saturation signal or a brightness signal such as an HSV signal, only the saturation can be changed. Accordingly, correction processing with a high degree of freedom can be achieved. For example, processing that increases the change in saturation without changing the brightness much can be performed.

As described above, the RGB image is converted into the HSV signal, but the conversion is not limited thereto. Any format other than the HSV signal can be used as long as the signal in which the saturation component or the brightness component is separated.

### Adjustment of Lowering Saturation and Lowering Brightness

The adjustment for lowering saturation and the lowering brightness in the saturation and brightness correction processing 3102 will be described below. The saturation and brightness correction unit 31 may switch the adjustment level of the lowering saturation and lowering brightness depending on the setting by the user when executing the saturation and brightness correction processing.

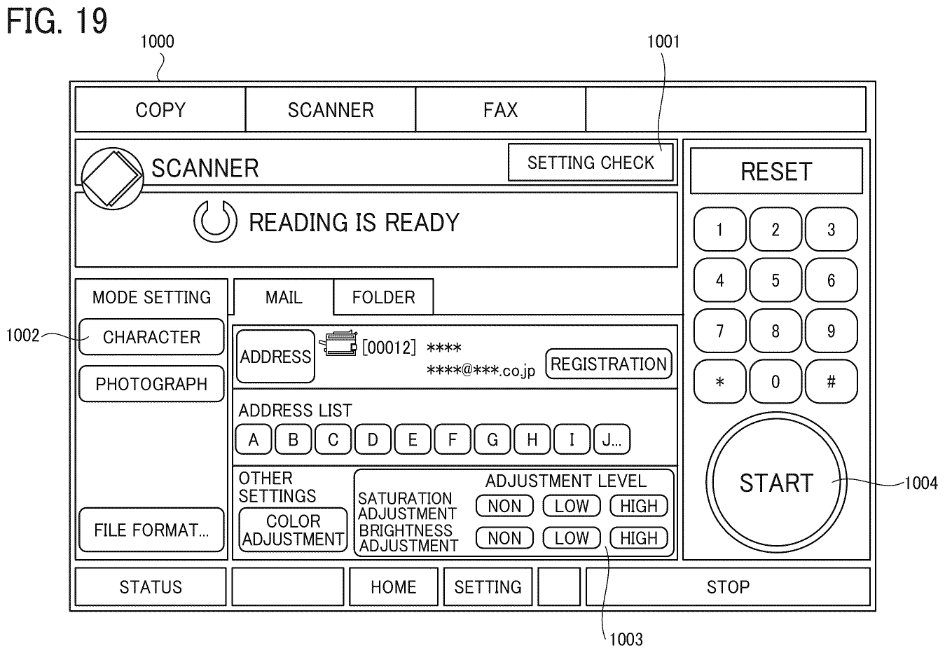

FIG. 19 is a diagram illustrating a diagram of a UI setting screen that performs saturation adjustment and brightness adjustment in the saturation and brightness correction 3102. The UI setting screen 1000 includes a setting check button 1001, and displays the setting information illustrated in FIG. 19 when the setting check button 1001 is touched.

In the setting information, the setting corresponding to the mode setting of the character 1002 is displayed. The adjustment information 1003 is adjustment information that adjusts the saturation and the brightness.

In the adjustment information 1003, adjustment coefficients (adjustment levels) of saturation and brightness are adjusted depending on setting values of saturation adjustment and brightness adjustment set by the user. In other words, in the adjustment information 1003, the strength of the saturation adjustment and brightness adjustment, or a selection of “execute” or “no-execute” can be changed depending on the saturation adjustment and the brightness adjustment set by the user. Accordingly, in the case where a color change of a black character (e.g., ink black or mat black) does not matter with respect to a target image, a more optimum image can be provided by intensifying adjustment to remove the imprint overlapping the black character. As described above, the adjustment is performed by strength. Further, the adjustment may be performed by an adjustment notch.

The UI setting screen 1000 accepts the setting of the luminance components of the black character and the non-black character via the adjustment buttons, and sets the setting in the saturation and brightness correction unit 31 when the start button 1004 is touched.

The adjustment information enables the user to adjust the saturation and the brightness depending on the document.

### Eighth Modification

In an eighth modification, a configuration for removing a designated color such as a ruled line will be described below.

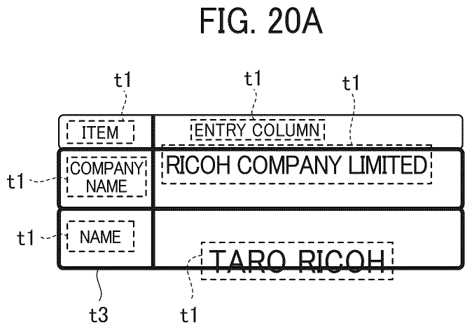

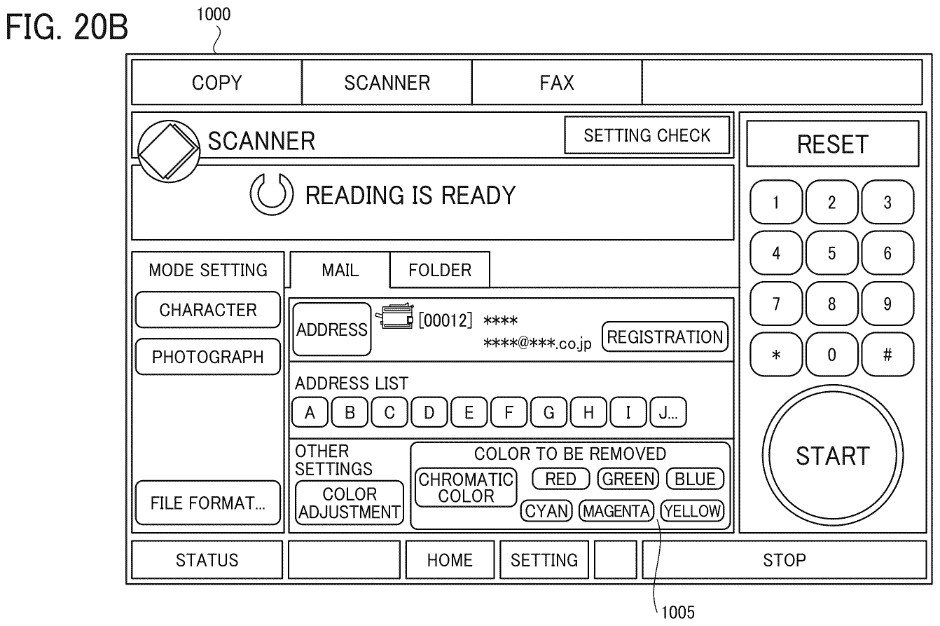

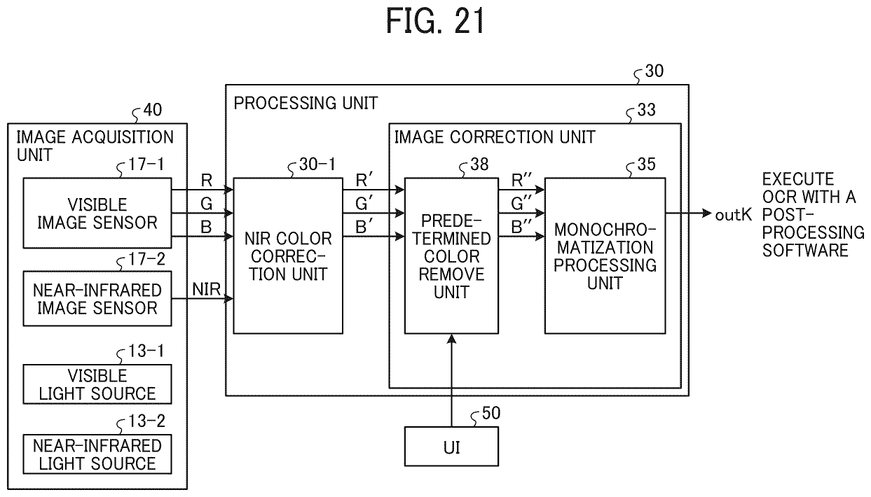

FIGS. 20A, 20B, and 21 are diagrams illustrating configurations for removing a designated color such as a ruled line. As illustrated in FIG. 20A, ruled lines t3 are often drawn in a ledger sheet to clear write-in columns. A region of black characters t1 filled in the column overlaps the ruled lines t3 by a positional displacement of print type or a positional displacement of handwriting. In the case where the OCR processing is performed in this state, the ruled lines t3 interfere with appropriate extraction of character information. Thus, as illustrated in FIG. 20B, a setting unit 1005 is disposed to instruct the removal of a designated color in the UI setting screen 1000. The setting unit 1005 is a setting unit for the user to designate a color to be removed. In FIG. 20B, color designation buttons such as chromatic color, red, green, blue, cyan, magenta, and yellow are disposed, and a color to be removed is selected from the color designation buttons by the user. The type of color and the method of designating the color are not limited thereto, and may be appropriately modified.

FIG. 21 is a diagram illustrating a configuration of an image correction unit according to an eighth modification. As illustrated in FIG. 21, the image correction unit 33 includes a designated color removal unit 38.

The designated color removal unit 38 performs the removal processing to the R′G′B′ image processed by the saturation and brightness correction in the near-infrared color correction unit 30-1 with respect to the designated color received by the UI 50 from the user via the UI setting screen 1000.

For example, in the case of removing a ruled line, the user designates a color corresponding to the color of the ruled line in the setting unit 1005, and removes the ruled line by removing the designated color.

In an embodiment of the present disclosure, the image processing device further includes an operation panel having a setting screen. The circuitry receives the predetermined color designated through the setting screen of the operation panel.

According to such a configuration, the ruled line can be removed, and the erroneous recognition of the character in the OCR processing can be prevented.

### Ninth Modification

A configuration that outputs an image after the monochromatization processing as a multi-level image at the time of output for the OCR image will be described below.

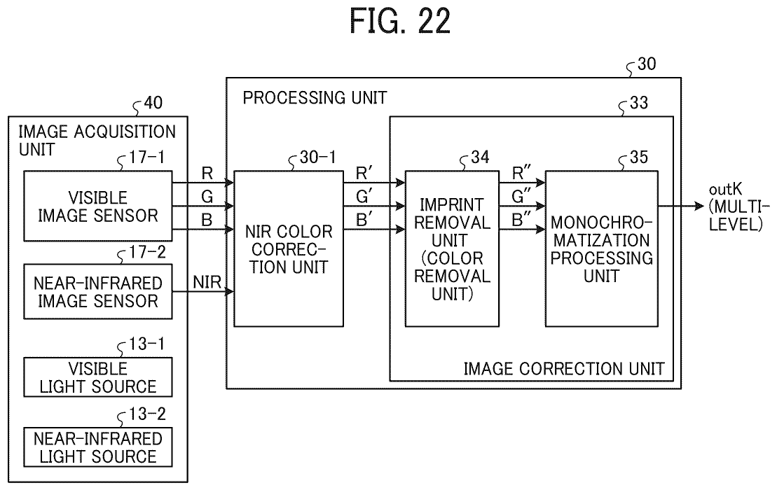

FIG. 22 is a diagram illustrating a configuration according to a ninth modification. As illustrated in FIG. 22, when a monochromatized image is output from the monochromatization processing unit 35, the output image is not a two-level (i.e., binary) image but a multiple-level image (multi-level monochromatized image). The multi-level monochromatized image is, for example, a gray scale image.

In an embodiment of the present disclosure, in the image processing device, the circuitry further outputs the monochromatized image data as multi-level image data.

As described above, since the multi-level image is output, the data can be sent to OCR software in the following processing without losing detail information around the character. In the case where the OCR software performs advanced binarization processing in the following processing, the processing can be effectively used, and the recognition ratio of the OCR processing is further increased.

Further, in FIG. 22, a configuration that outputs a single image of the monochromatized image alone is illustrated, but the configuration can also output multiple images including the RGB image as illustrated in FIG. 13.

### Tenth Modification

A configuration that performs binarization processing to the image after the monochromatization processing at a time of outputting the image for the OCR processing output will be described below.

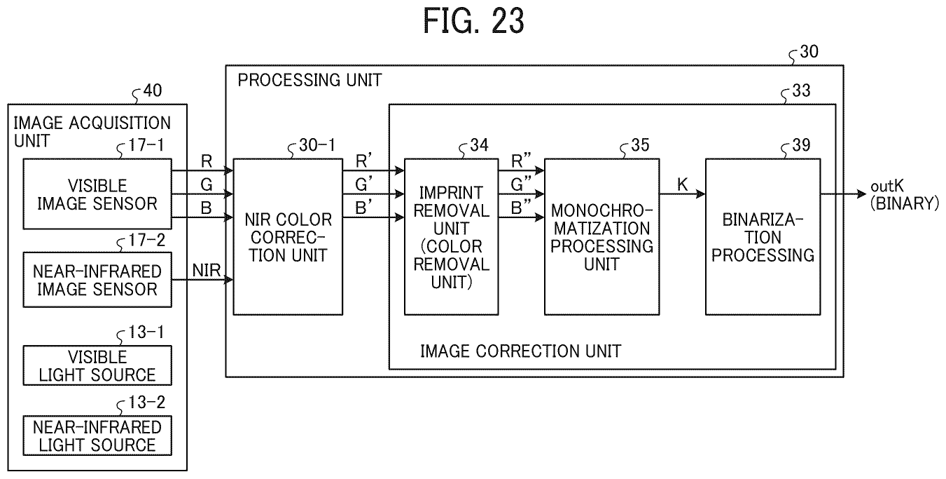

FIG. 23 is a diagram illustrating a configuration according to a tenth modification. As illustrated in FIG. 23, the image correction unit 33 includes the binarization processing unit 39.

The binarization processing unit 39 performs the binarization processing to the image after the monochromatization processing output from the monochromatization processing unit 35, and outputs a binary image as a monochromatized image.

In an embodiment of the present disclosure, the image processing device, the circuitry further binarizes the monochromatized image data to generate binary image data; and outputs the binary image data.

As described above, since the binary image is output, the amount of the data can be reduced. Further, since the binarization processing is performed in the image correction unit 33, parameters suitable for the image reading device can be used in the binarization processing. In this case, in the case where the OCR software in the following processing even has low accuracy in the binarization processing, the reading device performs the binarization processing and sends the processed data to the OCR software. As a result, the OCR recognition rate can be increased in spite of the accuracy of the binarization by the OCR software.

Further, in FIG. 23, a configuration that outputs a single image of the monochromatized image alone is illustrated, but the configuration can also be applied to the output of multiple images including the RGB image illustrated in FIG. 13.

### Second Embodiment

An image processing device may perform a part or all of processing for removing the imprint to the visible image, which are performed by the reading device 1 or the external device according to the first embodiment.

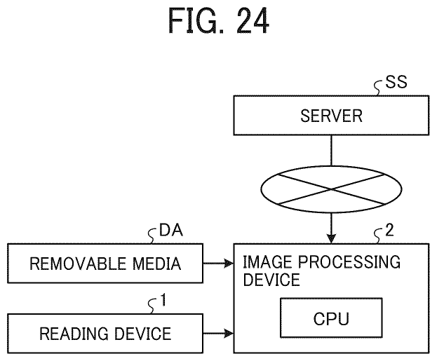

FIG. 24 is a diagram illustrating a configuration of a system including an image processing device 2 according to a second embodiment of the present disclosure. The image processing device 2 performs processing to remove an imprint by inputting a visible image and an invisible image output from the image reading device 1. Further, the image processing device 2 may acquire the visible image and the invisible image stored in a server SS and perform processing to remove the imprint. Further, the image processing device 2 may read the visible image and the invisible image from a portable storage medium such as a semiconductor memory and perform processing to remove the imprint.

The image processing apparatus 2 includes a CPU, and the CPU executes a predetermined program to perform various functions corresponding to the processing unit 30 and the NIR density level extraction unit 32, and various functions for removing an imprint from an image, and performing the OCR processing. Further, some or all of the various functions may be implemented by hardware such as an application specific integrated circuit (ASIC). The image processing device 2 outputs various images from an output unit to an external device such as a PC.

Since the various functions have been described in the reading device and the external device according to the first embodiment of the present disclosure, further description thereof will be omitted.

### Third Embodiment

The reading device according to the first embodiment and the image processing device according to the second embodiment may be mounted in an image forming apparatus.

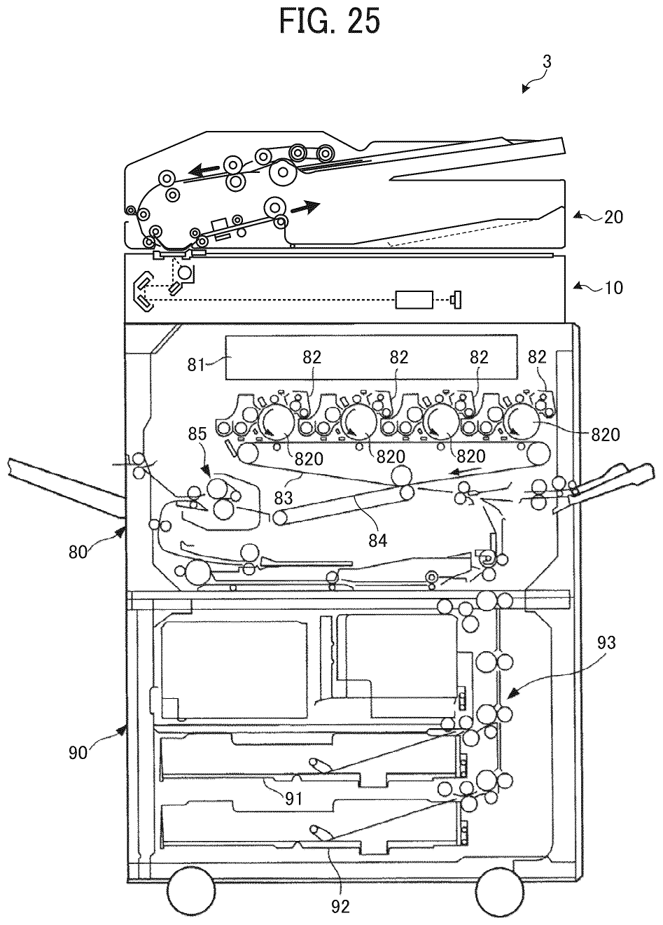

FIG. 25 is a diagram illustrating a configuration of an image forming apparatus 3 according to a third embodiment of the present disclosure. The image forming apparatus 3 illustrated in FIG. 25 is typically referred to as a multifunction peripheral or printer (MFP). The image forming apparatus 3 illustrated in FIG. 25 includes a reading device (a reading device main body 10 and an ADF 20) in an upper part of the image forming apparatus 3. The configuration of the reading device is the same as that of the first embodiment, and a detailed description thereof is omitted.

The image forming apparatus 3 illustrated in FIG. 25 includes an image forming unit 80 and a sheet feeding unit 90 under the reading device main body 10.

The image forming unit 80 prints a read image read by the reading device main body 10 on a recording sheet serving as a recording medium. The read image is a visible image or an invisible image.

The image forming unit 80 includes an optical writing unit 81, tandem image forming units (Y, M, C, and K) 82, an intermediate transfer belt 83, and a secondary transfer belt 84. In the image forming unit 80, the optical writing unit 81 writes images to be printed on the photoconductive drums 820 in the tandem image forming units (Y, M, C, and K) 82, and toner images are transferred on the intermediate transfer belt 83 from the photoconductive drums 820. A K image is formed by K toner including carbon black.

The image forming units (Y, M, C, and K) 82 include four photoconductive drums (Y, M, C, and K) 820 that are rotatable, and include image forming elements including a charging roller, a development unit, a primary transfer roller, a cleaner unit, and a discharge unit around each of the four photoconductive drums (Y, M, C, and K) 820. Since each of the image forming elements functions around the corresponding one of the four photoconductive drums (Y, M, C, and K) 820 with a predetermined image forming operation, each image is formed on the corresponding one of the four photoconductive drums (Y, M, C, and K) 820 and transferred on the intermediate transfer belt 83 as a toner image by the first transfer roller.

The intermediate transfer belt 83 is disposed to pass through nips between the photoconductive drums 820 and the primary transfer rollers and is stretched by a driving roller and driven rollers. The toner image primarily transferred to the intermediate transfer belt 83 is secondarily transferred to a recording sheet on the secondary transfer belt 84 by a secondary transfer device by running the intermediate transfer belt 83. The recording sheet is conveyed to a fixing device 85 by moving the secondary transfer belt 84, and the toner image is fixed on the recording sheet. The recording sheet is ejected to an ejection tray outside the apparatus.

For example, a sheet feeding unit 90 that stores recording sheets having different sheet sizes brings out the predetermined sheet from the sheet feeding cassettes 91 and 92, and the predetermined sheet is conveyed with a conveyance device 93 including various rollers and supplied to the secondary transfer belt 84.

The image forming unit 80 is not limited to the unit that forms an image by the electrophotographic method as described above, but may form an image by an ink jet method. Further, the image forming apparatus is not limited to the MFP. The image forming apparatus may be, for example, a printer that receives image data generated by a separate image processing device via communication and prints the received image data.

### Fourth Embodiment

The reading device according to the first embodiment or the image processing device according to the second embodiment may be mounted on a biological imaging apparatus.

In an embodiment of the present disclosure, an image forming apparatus includes the image processing device and an image forming unit to form an image based on the image data generated by the image processing device.

The imaging with infrared light described above may be used for biological imaging in a biological imaging apparatus because materials of a living tissue is less likely to absorb the light having a near-infrared wavelength region and the materials of the living tissue have high transmittance. As an application of the bioimaging in the bioimaging apparatus, the imaging is performed in combination with a dye that absorbs near-infrared light.

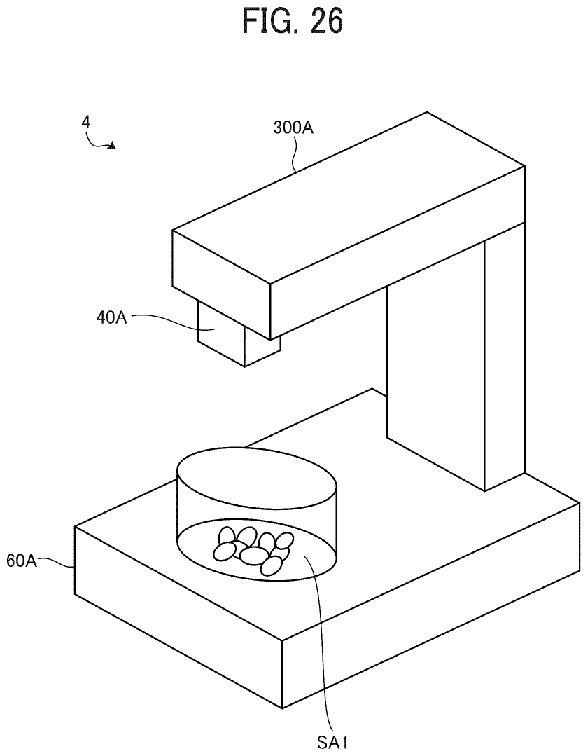

FIG. 26 is a diagram illustrating a configuration of a bioimaging apparatus according to a fourth embodiment of the present disclosure. A biological imaging apparatus 4 includes an imaging unit 40A, a control unit 300A, and a sample stage 60A, and generates an image easy to observe a specific cell and other cells at the same time based on the cell image obtained by the imaging unit 40A.

In an embodiment of the present disclosure, a biological imaging apparatus includes comprising the image processing device according to claim 1.

In FIG. 26, a sample SA1 sealed in a container is placed on a sample stage 60A that holds the object at an appropriate position. The imaging unit 40A acquires a visible image obtained by imaging multiple types of cells contained in the sample SA1 with visible light. In addition, the imaging unit 40A obtains a near-infrared image taken with the invisible light to the same object and determines the position of specific cells contained in a sample SA1. The control unit 300A includes a processing unit including a CPU and a memory, and performs a color correction of at least one of saturation or brightness to the visible image at the same position of the visible image with the position determined in the near-infrared image. In the color correction, as described above, the correction processing may be performed depending on the density value of the near-infrared image. The operations of acquiring the visible image and the near-infrared image in the imaging unit 40A and the operations of correcting the saturation and the brightness in the control unit 300A are the same as those in the first embodiment.

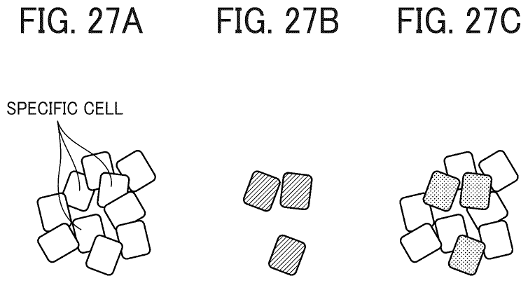

FIGS. 27A to 27C are diagrams illustrating an application of the bioimaging in the bioimaging apparatus according to the fourth embodiment of the present disclosure.

FIG. 27A is a diagram of a visible image of a collection of multiple types of cells acquired with visible light. As illustrated in FIG. 27A, there is a case where colors are the same on the visible image, but the type cannot be identified. In such a case, for the purpose of observing a specific cell, there is a case where a cell imaging with higher sensitivity than the visible light is conducted by performing the near-infrared imaging using a near-infrared absorbing dye that stains only the specific cell.

FIG. 27B is a diagram illustrating a near-infrared image of a collection of multiple types of cells acquired with invisible light (near-infrared light). As illustrated in in FIG. 27B, specific cells can be identified, but other cells cannot be identified only by near-infrared light due to light transmission.

FIG. 27C is a diagram illustrating a visible image of the group of multiple types of cells, which is processed by a color correction based on the near-infrared image. According to an embodiment of the present disclosure, an image in which a specific cell and other cells can be easily observed at the same time can be generated by performing a color correction of at least one of saturation and brightness to the visible image data based on the near-infrared image data at the same position of the visible image data with the position of the near-infrared image data.

The circuitry may include the image processing unit 2a, the extraction unit 3a, the image correction processing unit 405, the frame memory 406, the frame memory 406, the output control unit 407, the control unit 400, the processing unit 30, the NIR density level extraction unit 32, the controller 307, the near-infrared color correction unit 30-1, the saturation and brightness correction unit 31, the image correction unit 33, the imprint removal unit (color removal unit) 34, the monochromatization processing unit 35, the second image processing unit 36, the N-level conversion processing unit 3000, the threshold value determination unit 3500, the background level setting unit 37-1, the black level setting unit 37-2, the RGB-to-HSV conversion unit 3101, the HSV-to-RGB conversion unit 3103, the designated color removal unit 38, the binarization processing unit 39, or the like.

The embodiments and modifications of the present disclosure have been described above, but the embodiments and modifications are presented by way of example and are not intended to limit the scope of the invention. These embodiments and modifications can be implemented in various other forms, and various omissions, substitutions, and changes can be made without departing from the scope of the invention. These embodiments and modifications thereof are included in the scope and spirit of the invention, and are also included in the invention described in the claims and the equivalents thereof.

Aspects of the present disclosure are as follows, for example.

### First Aspect

An image processing device comprising: an input unit to receive visible image data of an object read by a first sensor having a sensitivity of light from a light source having a visible wavelength range and invisible image data of the object by a second sensor having a sensitivity of light from a light source having an invisible wavelength range; and an image processing unit to generate an image performed by a color correction of at least one of saturation or brightness to the visible image data based on the invisible image data at a same position of the visible image data with a position of an invisible image data.

### Second Aspect

The image processing device according to the first aspect further includes an invisible component density level extraction unit to extract density information expressing an absorptance of an invisible component at each position from the invisible image data. The image processing unit performs a color correction of at least one of saturation or brightness to the visible image data at a same position with a position of the invisible image data based on the density information of the invisible image data

### Third Aspect

In the image processing device according to the first aspect, the image processing unit performs a correction of at least one of lowering saturation or lowering brightness to the visible image data.

### Fourth Aspect

The image processing device according to the first aspect further includes an output unit to output the image data generated by the image processing unit to an external device.

### Fifth Aspect

In the image processing device according to the fourth aspect, the output unit outputs the visible image data of the object and the image data generated by the image processing unit to the external device.

### Sixth Aspect

The image processing device according to the fourth aspect further includes a predetermined color removal unit to generate a predetermined color removal image by removing a predetermined color from the image data generated by the image processing unit; and a monochromatization processing unit to generate a monochromatized image by monochromatizing the predetermined color removal image. The output unit outputs the monochromatized image to the external device.

### Seventh Aspect

In the image processing device according to the sixth aspect, he predetermined color removal unit removes a predetermined color set by a user from the image data generated by the image processing unit.

### Eighth Aspect

In the image processing device according to the sixth aspect, the image processing unit outputs the monochromatized image as a multi-level image.

### Ninth Aspect

In the image processing device according to the six aspect, the image processing unit outputs the monochromatized image binarized as a binary image.

### Tenth Aspect

In the image processing device according to the second aspect, the invisible component density level extraction unit outputs a result performed by N-level conversion processing as density information.

### Eleventh Aspect

In the image processing device according to the tenth aspect, the invisible component density level extract unit includes a threshold value determination unit to determine a threshold value based on a set background level and a set black level, and performs N-level conversion processing based on the threshold value determined by the threshold value determination unit.

### Twelfth Aspect

In the image processing device according to the eleventh aspect, the threshold value determination unit includes: a background detection unit to detect a background level of the visible image data of the object; and a black level detection unit to detect a black level of the visible image data of the object, and determines the threshold value corresponding to each region of the visible image data of the object based on the background level detected by the background detection unit and the black level detected by the black level detection unit.

### Thirteenth Aspect

In the image processing device according to thirteenth aspect, the image processing unit includes: a saturation and brightness conversion unit to convert first red-green-blue image data to a hue-saturation-brightness signal; and a red-green-blue conversion unit to perform a color correction of at least one of saturation or brightness to the hue-saturation-brightness signal at a same position of the hue-saturation-brightness signal with a position of invisible image data and convert the hue-saturation-brightness signals after the color correction to second red-green-blue data again.

### Fourteenth Aspect

In the image processing device according to the thirteenth aspect, the saturation and brightness conversion unit determines a saturation coefficient by a one-dimensional lookup table of saturation and a brightness coefficient by a one-dimensional lookup table of brightness, and corrects the density information of the invisible image data based on the saturation coefficient and the brightness coefficient.

### Fifteenth Aspect

In the image processing device according to the second aspect, the invisible component density level extraction unit uses a carbon content as the density information of the invisible image data.

### Sixteenth Aspect

A reading device includes the image processing device according to any one of the first to fifteenth aspects, a visible light source that emits light having a visible wavelength to the object, an invisible light source to emit light having an invisible wavelength to the object, a first image sensor to receive reflected light having a visible wavelength from the object and outputs visible image data, and a second image sensor to receive reflected light having an invisible wavelength from the object and output invisible image data.

### Seventeenth Aspect

An image forming apparatus includes the image processing device according to any one of the first to fifteenth aspects, and image forming unit to form an image based on the image data generated from the image processing device.

### Eighteenth Aspect

A data management system includes the image processing device according to the fourth or fifth aspect; and an information processing device to link the visible image data transmitted from the image processing device and the image data generated by the image processing unit and manage the visible image data and the image data.

### Nineteenth Aspect

A bioimaging apparatus comprising the image processing device according to any one of the first to fifteenth aspects

### Twentieth Aspect

An image processing method to process a visible image data of an object read by a sensor having a sensitivity of light from a light source having a visible wavelength includes inputting the visible image data of the object and an invisible image data of the object red by a sensor having a sensitivity of light from a light source having an invisible wavelength and generating an image data corrected by a color correction of at least one of saturation or brightness with respect to the visible image data based on a same position of the visible data with a position of the invisible image data.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Any one of the above-described operations may be performed in various other ways, for example, in an order different from the one described above.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), a digital signal processor (DSP), a field programmable gate array (FPGA), and conventional circuit components arranged to perform the recited functions.

1. An image processing device comprising:
a first sensor having a sensitivity of a visible wavelength range, to read visible image data of an object;
a second sensor having a sensitivity of an invisible wavelength range to read invisible image data of the object; and
circuitry configured to perform a color correction to correct a color of at least one of saturation or brightness to the visible image data based on the invisible image data at a same position with a position of the visible image data to generate image data.

2. The image processing device according to claim 1,
wherein the circuitry is further configured to:
extract density information, expressing an absorptance of an invisible component at each position, from the invisible image data; and
perform the color correction of at least one of the saturation or the brightness to the invisible image data at the same position with the position of the visible image data based on the density information of the invisible image data.

3. The image processing device according to claim 1,
wherein the circuitry is configured to perform at least one of:
lowering the saturation; or
lowering the brightness,
to the visible image data.

4. The image processing device according to claim 1,
wherein the circuitry is further configured to output the image data to an external device.

5. The image processing device according to claim 4,
wherein the circuitry is further configured to output the visible image data of the object to the external device.

6. The image processing device according to claim 4,
wherein the circuitry is further configured to:
generate color-removed image data by removing a predetermined color from the image data;
generate monochromatized image data by monochromatizing the color-removed image data; and
output the monochromatized image data to the external device.

7. The image processing device according to claim 6, further comprising an operation panel having a setting screen, and
wherein the circuitry receives the predetermined color designated through the setting screen of the operation panel.

8. The image processing device according to claim 6,
wherein the circuitry is further configured to output the monochromatized image data as multi-level image data.

9. The image processing device according to claim 6,
wherein the circuitry is further configured to:
binarize the monochromatized image data to generate binary image data; and
output the binary image data.

10. The image processing device according to claim 2,
wherein the circuitry is further configured to:
perform N-level conversion processing to the invisible image data to obtain the density information; and
output the density information obtained by the N-level conversion processing.

11. The image processing device according to claim 10,
wherein the circuitry is further configured to:
determine a threshold value based on:
a predetermined background level; and
a predetermined black level; and
perform the N-level conversion processing to the invisible image data based on the threshold value.

12. The image processing device according to claim 11,
wherein the circuitry is further configured to:
detect a background level of the visible image data of the object;
detect a black level of the visible image data of the object; and
determine a threshold value corresponding to each region of the visible image data of the object based on the background level and the black level.

13. The image processing device according to claim 2,
wherein the circuitry is further configured to:
convert red-green-blue image data into a hue-saturation-brightness signal;
perform the color correction of at least one of the saturation or the brightness to the hue-saturation-brightness signal at the same position with the position of the invisible image data based on the density information of the invisible image data; and
reconvert the hue-saturation-brightness signal after the color correction into the red-green-blue image data.

14. The image processing device according to claim 13,
wherein the circuitry is further configured to:
determine a saturation adjustment coefficient by a one-dimensional lookup table of a saturation adjustment coefficient and a brightness adjustment coefficient by a one-dimensional lookup table of the brightness with respect to the density information of the invisible image data; and
perform the color correction based on the saturation adjustment coefficient and the brightness adjustment coefficient.

15. The image processing device according to claim 2,
wherein the circuitry is further configured to use a carbon content as the density information of the invisible image data.

16. A reading device comprising:
the image processing device according to claim 1;
a visible light source to emit light having a visible wavelength range to the object; and
an invisible light source to emit light having an invisible wavelength range to the object,
wherein the first sensor:
receives reflection light, having visible wavelength, reflected from the object; and
outputs the visible image data, and
the second sensor:
receives reflection light, having an invisible wavelength, reflected from the object; and
outputs the invisible image data.

17. An image forming apparatus comprising:
the image processing device according to claim 1; and
an image forming unit to form an image based on the image data generated by the image processing device.

18. A data management system comprising;
the image processing device according to claim 4; and
an information processing device to link:
the visible image data sent from the image processing device; and
the image data generated by the circuitry,
to manage the visible image data and the image data.

19. A biological imaging apparatus comprising the image processing device according to claim 1.

20. An image processing method comprising:
causing a first sensor having a first sensitivity in a visible wavelength range to acquire visible image data of an object;
causing a second sensor having a second sensitivity in an invisible wavelength range to acquire invisible image data of the object; and
performing a color correction to correct a color of at least one of saturation or brightness to the visible image data based on the invisible image data at a same position with a position of the visible image data to generate image data.
